(19) United States
(12) Patent Application Publication
(10) Pub. No.: US 2005/0233281 A1
(43) Pub. Date: Oct. 20, 2005

(54) Uniquely positioned, winged, low profile impression cap for use with triple tray

(76) Inventor: Neal B. Gittleman, Houston, TX (US)

Correspondence Address: EZRA L. SCHACHT, 1620 W. MAIN ST., HOUSTON, TX, 77006-4712, US

(21) Appl. No.: 10/827,169

(22) Filed: Apr. 19, 2004

(51) Int. Cl. A61C 8/00; A61C 13/12

(52) U.S. Cl. 433/173; 433/172

(57) ABSTRACT

By aligning a single projection against a matching surface, a low profile, winged impression cap is placed in a unique clocking position over a low profile impression post or an installed implant abutment. The low profile allows the complete centric closure of the jaw and the use of the time and material saving triple tray to reduce the cost and improve the final accuracy in the fitting of a dental restoration.

### BACKGROUND OF THE INVENTION

The need to save time and improve the accuracy in the preparation of crowns and bridges with implants drives the modern competitive dentist. The dentist takes advantage of the use of the triple tray to speed the taking of simultaneous impressions of the upper and lower dentition and a bite pattern during centric closure. Triple trays cannot be used if standard tall impression posts are used. This invention combines a short impression post and impression cap with a low profile that will not interfere with a complete closure of the jaws. The post and cap have been further refined to a single orientation to avoid potential mistakes in the lab.

In the inventor's prior patent application Ser. No. 09/828,593 now issued as U.S. Pat. No. 6,508,650, the inventor teaches a low profile, non-interfering dental implant impression cap for making time saving and accurate, simultaneous upper and lower impressions and bite registration with the jaw accurately positioned in centric closure. Featured in that invention are a number of symmetrical projections or surfaces that allow the choice of several possible clocking positions of the low profile impression cap on the impression post. The inventor feels that this could lead to potential error of communication between the dental surgeon and the lab, resulting in an improperly clocked prosthesis. This invention removes this ambiguity by offering a single clocking orientation.

### A BRIEF DESCRIPTION OF THE DRAWINGS

FIG. 1 is a prior art exploded perspective view of implant, impression post and cap with multiple positioning means;

FIG. 2 is an exploded perspective view of an implant, an impression post and low profile, winged cap with a single locking and clocking means;

FIG. 3 is an exploded perspective view of an extended impression post with matching low profile, winged impression cap;

FIG. 4 is a side-by-side, exploded perspective view of shorter and longer impression cap system that accommodates differing bone and soft tissue heights;

FIG. 5 is a tapered abutment with single flat over alignment lobe; and

FIG. 6 is a cut away perspective view of a low profile winged impression cap with snap ridge and unique internal flat.

### DETAILED DESCRIPTION OF THE DRAWING

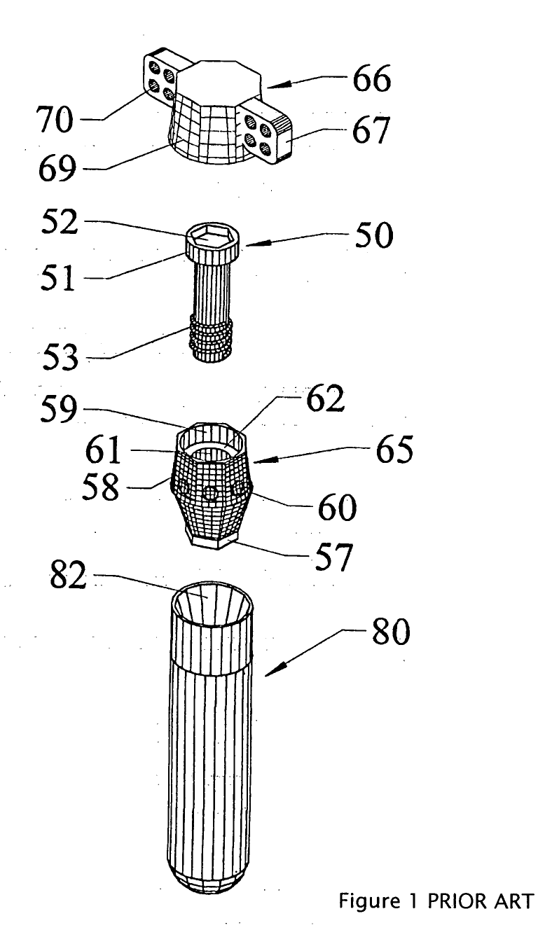

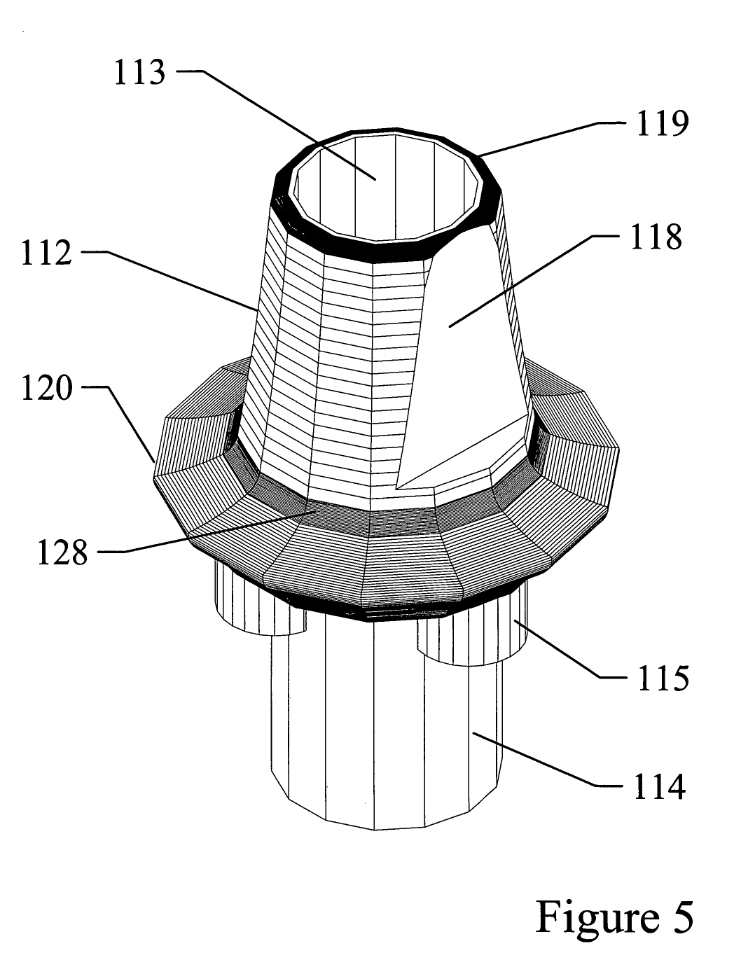

FIG. 1 in the prior art (FIG. 5 of U.S. Pat. No. 6,508,650) teaches a multi-sided truncated pyramidal upper surface 58 for the implant impression post 65 with multiple symmetrical locking means 60. This does not uniquely define a single position for the perforated wings 67 of the impression cap 66. The impression cap body 69 has a radial symmetrical recess on the underside with locking means. Multiple clocking positions are allowed by rotating the cap relative to the impression post.

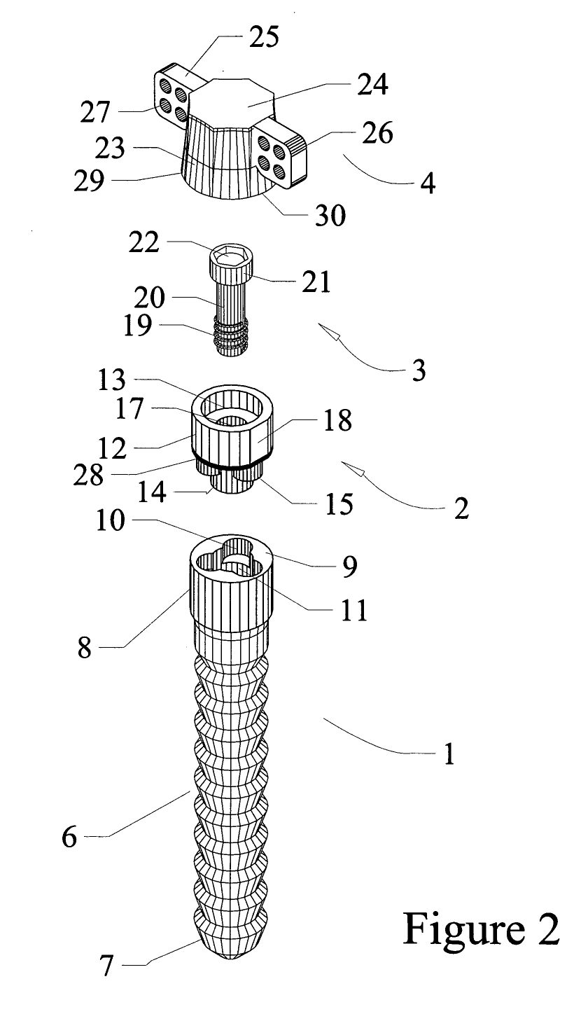

FIG. 2 shows an expanded view of the invention. Implant 1 has a threaded cylindrical shaft 6 with a self -starting distal end 7 and an attachment end 8. The upper surface 9 of the implant has a threaded blind hole 11 with a lobular recess 10 which serves the dual purpose of providing a drive insertion means and an abutment locking and clocking means. This lobular recess 10 shown with three lobes is characteristic of a line of implant fixtures manufactured and sold by Nobel Biocare and are not claimed as a substantive portion of the invention. Any clocking pattern, such as a square or hex or other geometric projection that mates with a matching recess that can be oriented with one face toward the buccal are anticipated by the invention. Low profile impression post 2 has an upper tapered cylindrical segment 12 having a recess 13 with a countersunk ledge and an axial through-hole 17. Flat surface 18 serves to properly align the winged impression cap 4. Perforated wings 25 and 26 on the winged impression cap 4 are perpendicular to the flat 18 when viewed from above. Lobes 15 on the impression post 2 match the lobed recess 10. The dental surgeon threads the implant fixture into a hole drilled into the jawbone and orients one of the lobes 11 in the buccal direction. The dentist installs the impression post with the flat 18 aligned with the buccal lobe 11. Hollow cylindrical projection 14 extends into hole 11 a short distance. Screw 3 with shaft 20 and threaded distal end 19 is used to hold the low profile impression post in place atop the implant. Screw 3 is equipped with a cap head 21 with a recessed hexagonal drive means 22.

The impression cap 4 has an internal circumferential snap ridge 29 that fits closely with a circumferential groove 28 surrounding the base of the taped cylindrical segment 12 of the impression post. The impression cap body 23 has a internal conformal socket that closely fits over cylindrical segment 12. An internal flat projection 30 aligned substantially perpendicular with the length of wing 26 that matches the flat 18 on the impression post. This matching flat and flat projection prevent any other orientation of the impression cap and impression post. The audible snap of the ridge 29 into the groove 28 as the impression cap is seated upon the impression post confirms the proper alignment and fit. Perforations 27 help to retain the impression cap within the impression compound.

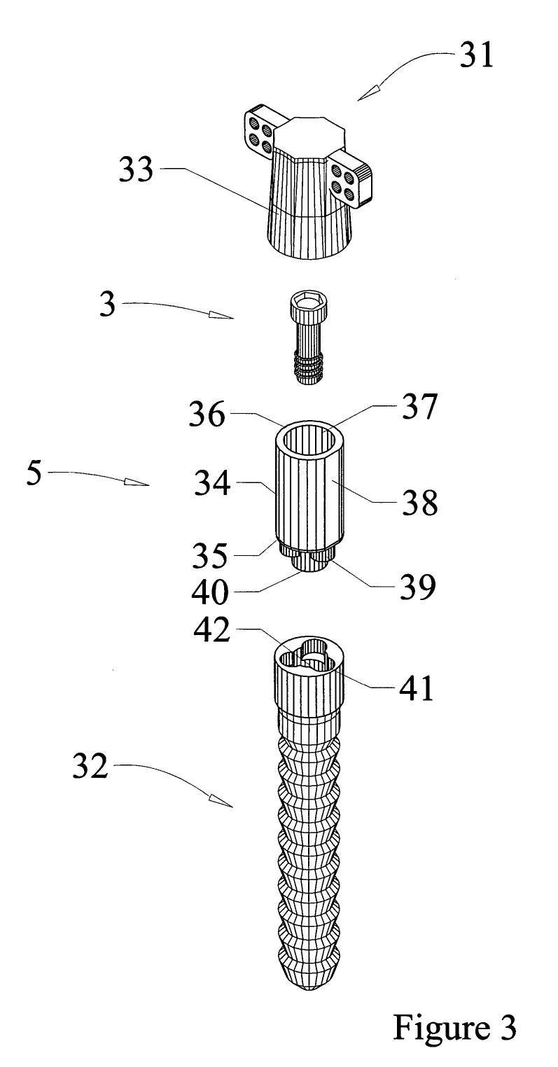

FIG. 3 shows a longer impression post 5 and impression cap 31. In those circumstances where uneven bone loss requires varying implant installation depths or the soft tissue margin and aesthetics need a taller implant abutment, this invention anticipates implant posts of several lengths. Lengths of 2, 4 and 6 mm are contemplated, but other lengths are included in the invention. Implant impression post 5 has a longer body 34 with a circumferential snap groove 35 to engage with the internal snap projection of winged impression cap 31. The body 33 of the impression cap is lengthened to mate with the longer body 34 of the impression post. Impression caps are provided in a kit of several lengths to mate with a kit of impression posts of varying lengths. The impression post 5 is retained by screw 3 through the top surface 36 within the countersunk through-hole 37 of the impression post. Flat 38 is located directly over lobe 39 which mates with recess 41 of the implant 32. Lobed recess 41 is pointed toward the buccal direction during the installation of the implant. The flat 38 can be anodized or color-coded to aid installation. The hollow cylindrical projection 40 of the impression post fits within recess 42 of the implant. Threads within the recess 42 mate with the threads of screw 3.

In some cases the dentist and dental surgeon install the final abutments in place of the impression posts. A kit of low profile, winged impression caps with internal recesses to mate with and match each abutment type is anticipated. Each impression cap can be color-coded to match a given abutment. Each abutment is manufactured with a recessed ring and a flat surface to snap lock and properly clock with the impression cap.

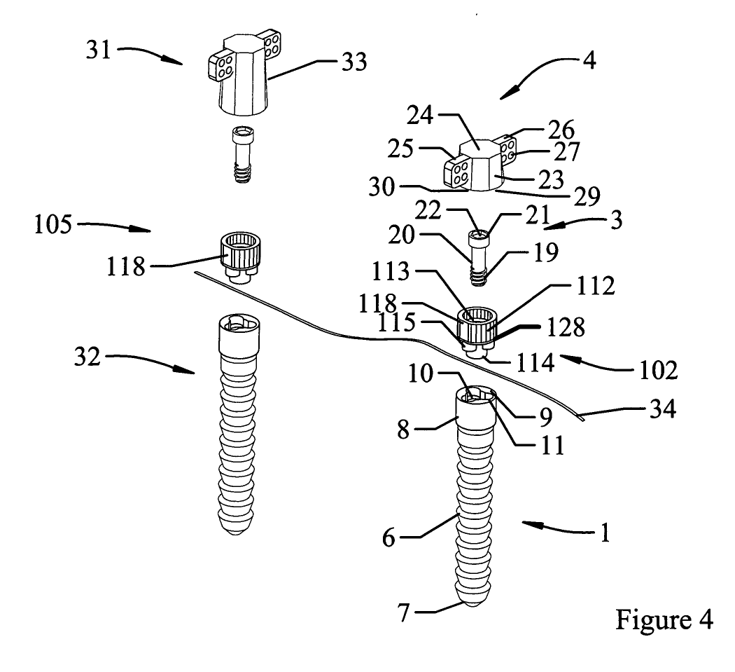

As an example, FIG. 4 illustrates implants 1 and 32 set to varying depths where line 34 schematically represents the soft tissue line. In this case, implant abutments 102 and 105 are of same length. Using a low profile winged impression cap with elongated body 33 places the tops 24 of winged impression caps 4 and 31 in approximately the same plane below the occlusal plane. Abutment 1 02 has a tapered or straight cylinder 112 with the top end having the same or smaller diameter. A snap retention groove 128 mates with a circumferential projection within the underside recess of impression cap 4 and 31. Flat 118 uniquely clocks and mates a flat projection within the winged impression cap. Countersunk through hole 113 in combination with internal thread in the implant 1 and screw 3 hold the abutment and implant together.

FIG. 5 is an abutment with a truncated tapered conical surface 112 with flat 118. The flat is located directly over lobular projection 115. Circumferential groove 128 mates with and locks to the low profile winged impression cap internal snap ridge or rim. Upper surface 119 has a countersunk through-hole 113 to accommodate an attachment screw. Lower cylindrical barrel 11 4 and lobular projects 115 mate with the exposed top of the implant.

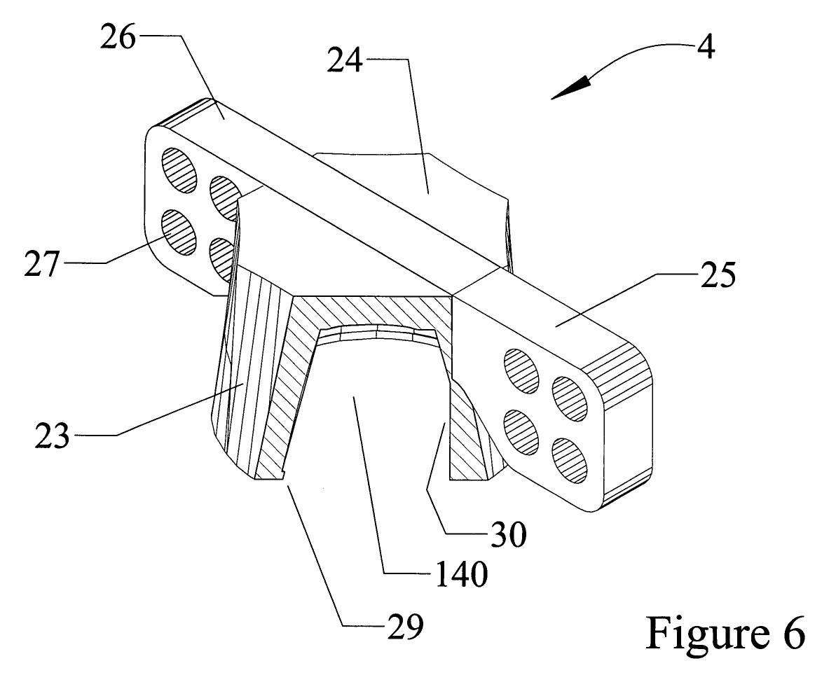

FIG. 6 is a sectioned perspective view of a low profile winged impression cap showing the internal flat 30 which clocks to the abutment or implant post flat 118. Circumferential snap ridge 29 locks into circumferential groove 128 located on the abutment or the impression post. Internal recess 140 of the cap is conforms with the top of the impression post. Impression caps intended for directly snapping onto an abutment can be manufactured with internal space 140 closely fitting the top of the abutment. Perforated wing 25 is aligned with flat 30. It is intended that winged impression caps can be manufactured for each style of abutment or impression post.

The steps in applying the invention are as follows:

An implant is set using standard surgical procedures. The implant is set with one of the recessed lobes set toward the buccal side. A healing cap is fixed in place. After the appropriate healing time the healing cap is removed and the implant is fitted with an impression post with the flat facing the buccal side. The screw holds the post in place. The winged impression cap is snapped in place in its unique position. The wings are oriented in the lingual to buccal position and do not interfere with the proximal teeth. The low profile of the impression post and cap do not extend into the occlusal plane or interfere with complete closure.

A triple tray is loaded with polymer compound on the upper and lower side and an impression is taken. The triple tray impression is removed with the winged impression cap snapped free of the impression post and the cap remaining firmly embedded within the polymer. The impression post is removed from the implant and an implant analog post is attached to the impression post with the screw. The implant analog post is equipped with a lobular recess. The impression post is snapped back into the impression cap in the unique position determined by the flat. The analog post is now aligned axially and radially in the same relative position as the implant was to the impression post.

At the dental lab the upper and lower impressions are cast, capturing the implant analog posts and preserving the orientation of the original implants. The stone casting is removed from the impression material along with the implant post and retaining screw. The impression cap remains embedded within the polymer. The upper and lower casts are mounted on articulator plates. A prosthesis is constructed upon these stone models by means know to the art. The objective is to maintain a dimensionally accurate transfer of all components from the mouth to the articulator.

Additionally, the inventor envisions a kit of low profile winged impression caps molded from different colored plastic compounds, each representing a fixed angle of orientation of the lengthwise direction of the wings of the cap in relation to the internal flat within the cap recess. Angles of plus or minus 20 degrees or of other fixed angles will suffice in unusual dental geometries.

1. A dental implant registration apparatus comprising:
an impression post having a lower, implant compatible, clocking and locking means;
a tapered, truncated, conical upper region having a single flat face and a circumferential retaining groove;
a top surface with a counter-sunk, axial through-hole for an implant-compatible mounting machine screw; and
a low profile impression cap with perforated side wings and with a tapered, truncated, conical recess having a single flat projection clocking with said single flat face of said impression post;
said low profile impression cap having a circumferential inward projecting ridge snapping into and mating with said circumferential retaining groove in said impression post.

2. A dental implant registration apparatus as cited in claim 1 comprising said perforated side wings oriented lengthwise perpendicular to said single flat projection to avoid interference with proximal teeth.

3. A dental implant registration apparatus comprising a kit of several said low profile impression caps having said perforated side wings oriented lengthwise at various fixed angles other than perpendicular to said single flat face to avoid interference with the proximal teeth.

4. A dental implant registration apparatus comprising:
an implant abutment having
a lower, implant compatible, clocking and locking means;
a tapered, truncated, conical upper region having a single flat face and a circumferential retaining groove;
a top surface with a counter-sunk, axial through-hole for an implant-compatible mounting machine screw; and
a low profile impression cap with perforated side wings and with a tapered, truncated, conical recess having a single flat projection clocking with said single flat face of said implant abutment;
said low profile impression cap having a circumferential inward projecting ridge snapping into and mating with said circumferential retaining groove in said implant abutment.
